(19) United States
(12) Patent Application Publication
(10) Pub. No.: US 2016/0344573 A1
(43) Pub. Date: Nov. 24, 2016

(54) METHOD AND APPARATUS FOR PROCESSING INTERACTIONS BETWEEN DEVICES

(71) Applicant: Xiaomi Inc., Beijing (CN)

(72) Inventors: Benchang SU, Beijing (CN); Enxing HOU, Beijing (CN); Ziguang GAO, Beijing (CN)

(73) Assignee: Xiaomi Inc.

(21) Appl. No.: 15/084,796

(22) Filed: Mar. 30, 2016

(30) Foreign Application Priority Data
May 20, 2015 (CN) 201510260776.1

(51) Int. Cl. H04L 12/66

(52) U.S. Cl. CPC H04L 12/66

(57) ABSTRACT

A method for processing interactions between devices, includes: obtaining an interaction triggering message sent from a first device belonging to the gateway and including an identification of the first device; searching for an interaction execution message of a second device corresponding to the interaction triggering message from a pre-stored interaction binding message, according to the identification of the first device, wherein the second device belongs to the gateway and the interaction binding message includes an interaction logic between the first device and the second device; and sending the interaction execution message to the second device, wherein the second device is configured to operate according to the interaction execution message.

### CROSS-REFERENCE TO RELATED APPLICATIONS

This application is based upon and claims priority to Chinese Patent Application No. 201510260776.1, filed on May 20, 2015, the entire contents of which are incorporated herein by reference.

### TECHNICAL FIELD

The present disclosure generally relates to the field of wireless network technology, and more particularly, to a method and an apparatus for processing interactions between devices.

### BACKGROUND

A gateway is also called a network connector or a protocol converter, and is a complex device configured to realize an interconnection between devices above a network layer. The gateway is commonly used for a connection of two networks with different high layer protocols. In an Internet network, the gateway is an intermediate device configured to connect an internal network with other devices in the Internet, and is also called a router. Some devices using non-TCP/IP protocols must communicate with other devices in the Internet via a special network.

In the current field of smart homes, a plurality of wireless protocols (such as a Bluetooth protocol and a Zigbee protocol) have been applied. These devices communicate with one another by using their own protocols and communicate with other devices in the Internet after the gateway performs a protocol conversion. An interaction logic between the devices is generally managed by a server.

### SUMMARY

According to a first aspect of the present disclosure, there is provided a method used in a gateway for processing interactions between devices. The method includes: obtaining an interaction triggering message sent from a first device belonging to the gateway and including an identification of the first device; searching for an interaction execution message of a second device corresponding to the interaction triggering message from a pre-stored interaction binding message, according to the identification of the first device, wherein the second device belongs to the gateway and the interaction binding message includes an interaction logic between the first device and the second device; and sending the interaction execution message to the second device, wherein the second device is configured to operate according to the interaction execution message.

According to a second aspect of the present disclosure, there is provided an apparatus used in a gateway for processing interactions between devices. The apparatus includes: a processor; and a memory for storing instructions executable by the processor. The processor is configured to: obtain an interaction triggering message sent from a first device belonging to the gateway and including an identification of the first device; search for an interaction execution message of a second device corresponding to the interaction triggering message from a pre-stored interaction binding message, according to the identification of the first device, wherein the second device belongs to the gateway and the interaction binding message includes an interaction logic between the first device and the second device; and send the interaction execution message to the second device, wherein the second device is configured to operate according to the interaction execution message.

According to a third aspect of embodiments of the present disclosure, there is provided a non-transitory computer-readable storage medium having stored therein instructions that, when executed by a processor of a gateway, cause the gateway to perform a method for processing interactions between devices. The method includes: obtaining an interaction triggering message sent from a first device belonging to the gateway and including an identification of the first device; searching for an interaction execution message of a second device corresponding to the interaction triggering message from a pre-stored interaction binding message, according to the identification of the first device, wherein the second device belongs to the gateway and the interaction binding message includes an interaction logic between the first device and the second device; and sending the interaction execution message to the second device, wherein the second device is configured to operate according to the interaction execution message.

Technical solutions provided by the present disclosure have following significant effects.

The above technical solutions manage the interaction logic between the devices through the gateway, which reduces the burden of the server and improves the execution efficiency of the interaction logic between the devices. Moreover, since the interactions between the devices do not need to be performed by using the server, the problem that the response speed is low or there is no response as a result of communication congestion between the device and the server can be avoided.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a method used in a gateway for processing interactions between devices, according to an exemplary embodiment.

FIG. 2 is a flow chart showing a method used in a gateway for processing interactions between devices, according to another exemplary embodiment.

FIG. 3 is a flow chart showing a method used in a gateway for processing interactions between devices, according to another exemplary embodiment.

FIG. 4 is a flow chart showing a method used in a gateway for processing interactions between devices, according to another exemplary embodiment.

FIG. 5 is a flow chart showing a method used in a server for processing interactions between devices, according to an exemplary embodiment.

FIG. 6 is a flow chart showing a method used in a server for processing interactions between devices, according to another exemplary embodiment.

FIG. 7 is a flow chart showing a method used in a server for processing interactions between devices, according to another exemplary embodiment.

FIG. 8 is a block diagram illustrating an apparatus in a gateway for processing interactions between devices, according to an exemplary embodiment.

FIG. 9 is a block diagram illustrating an apparatus in a gateway for processing interactions between devices, according to another exemplary embodiment.

FIG. 10 is a block diagram illustrating an apparatus in a gateway for processing interactions between devices, according to another exemplary embodiment.

FIG. 11 is a block diagram illustrating an apparatus in a gateway for processing interactions between devices, according to another exemplary embodiment.

FIG. 12 is a block diagram illustrating an apparatus in a server for processing interactions between devices, according to an exemplary embodiment.

FIG. 13 is a block diagram illustrating an apparatus in a server for processing interactions between devices, according to another exemplary embodiment.

FIG. 14 is a block diagram illustrating an apparatus in a server for processing interactions between devices, according to another exemplary embodiment.

FIG. 15 is a block diagram illustrating an apparatus for processing interactions between devices, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure.

A technical solution provided by the present disclosure relates to a server, a gateway, and devices belonging to the gateway. In the present disclosure, a device belongs to the gateway if the device communicates with any other device, including the server, via the gateway. The server is configured to obtain an interaction binding message between devices and to send the interaction binding message to the gateway. The gateway is configured to store the interaction binding message and to establish a binding relationship between the devices contained in the interaction binding message according to the interaction binding message, so as to control an operation of a device according to an interaction triggering message from another device. The devices belonging to the gateway is configured to send an interaction triggering message to the gateway when an interaction triggering requirement is satisfied, or to receive an interaction execution message sent from the gateway and to operate according to the interaction execution message. In this process, an interaction logic between the devices is managed through the gateway, which reduces the burden of the server and improves the execution efficiency of the interaction logic between the devices. Moreover, since the interactions between the devices do not need to be performed by using the server, a problem that a response speed is low or there is no response as a result of a communication block between the devices and the server is avoided.

Embodiments of the present disclosure provide a method for processing interactions between devices, and an execution body configured to perform the method includes the gateway and the server. Embodiments of the present disclosure arrange the method for processing interactions between devices according to different execution bodies, as described in the following.

Gateway Side

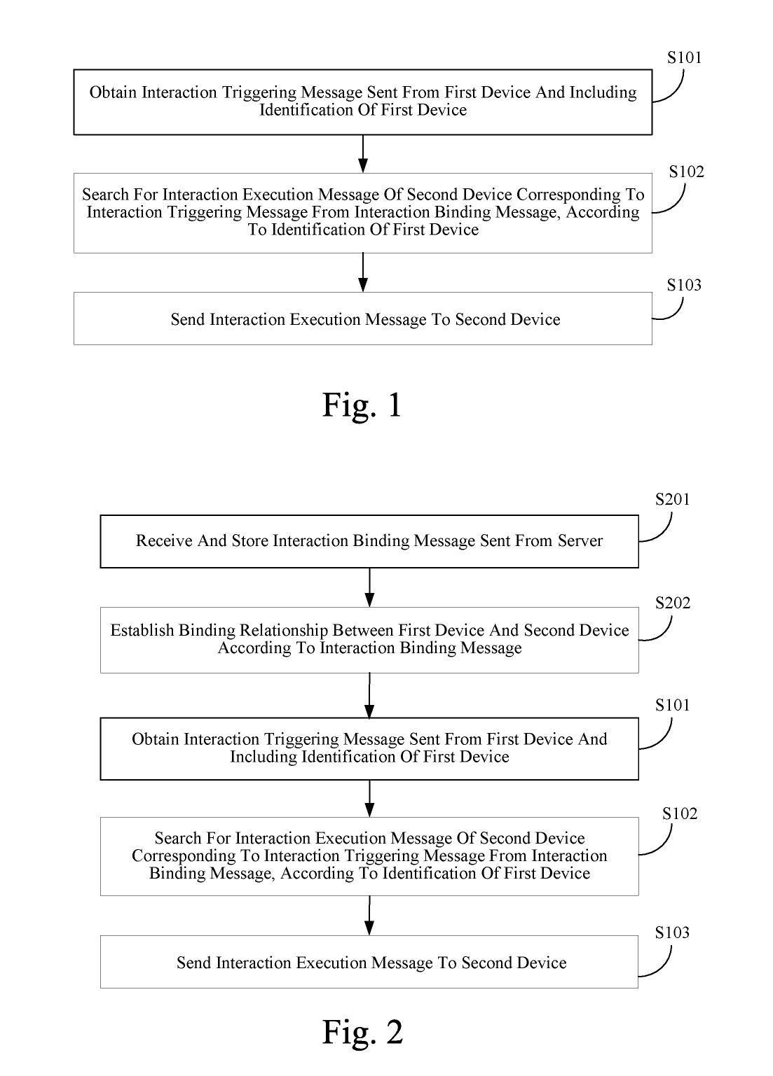

FIG. 1 is a flow chart showing a method used in a gateway for processing interactions between devices, according to an exemplary embodiment. The method for processing interactions between devices includes steps S101-S103.

In step S101, an interaction triggering message sent from a first device and including an identification of the first device is obtained. The first device belongs to the gateway.

In step S102, an interaction execution message of a second device corresponding to the interaction triggering message is searched for from a pre-stored interaction binding message, according to the identification of the first device. The second device belongs to the gateway. The interaction binding message includes an interaction logic between the first device and the second device.

In exemplary embodiments, the interaction logic is a logic of performing interaction operations between the first device and the second device. The interaction binding message may include the identification of the first device, an identification of the second device, the interaction triggering message of the first device, and the interaction execution message of the second device corresponding to the interaction triggering message. Once the gateway receives the interaction triggering message sent from the first device, the second device needs to operate according to the interaction execution message.

In step S103, the interaction execution message is sent to the second device. The second device is configured to operate according to the interaction execution message.

The interaction execution message may include operation parameters of the second device. For example, the second device may be an air conditioner, and the interaction execution message includes specific operation parameters of the air conditioner, such as an air conditioner mode, a set temperature, and so on, besides an air conditioner starting message, so as to facilitate operations of the air conditioner.

In this embodiment, the interaction logic between the devices is managed through the gateway, which reduces the burden of the server and improves the execution efficiency of the interaction logic between the devices. Moreover, since the interactions between the devices do not need to be performed by using the server, the problem that a response speed is low or there is no response as a result of a communication block between the devices and the server is avoided.

FIG. 2 is a flow chart showing a method used in a gateway for processing interactions between devices, according to another exemplary embodiment. As shown in FIG. 2, in the embodiment, before step S101, the method shown in FIG. 1 further includes steps S201-S202.

In step S201, the interaction binding message sent from a server is received and stored.

In step S202, a binding relationship between the first device and the second device is established according to the interaction binding message.

In this embodiment, with the interaction binding message, the binding relationship between the first device and the second device is established, and thus the second device can be controlled to operate according to a state of the first device.

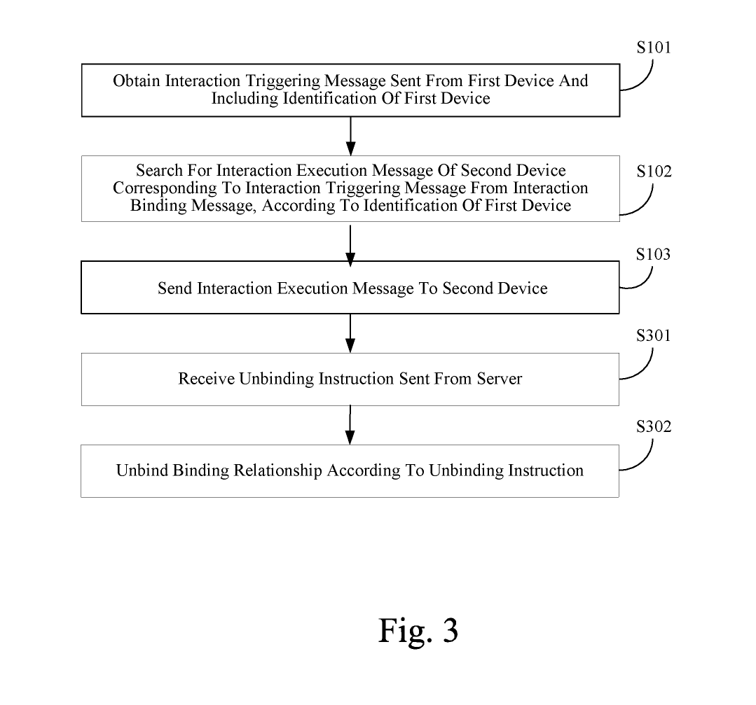

FIG. 3 is a flow chart showing a method used in a gateway for processing interactions between devices, according to another exemplary embodiment. As shown in FIG. 3, in the embodiment, the method shown in FIG. 1 further includes steps S301-S302.

In step S301, an unbinding instruction for unbinding the binding relationship sent from the server is received.

In step S302, the binding relationship is unbound according to the unbinding instruction.

In this embodiment, two devices with the established binding relationship can be unbound, and the two unbound devices will not operate according to the interaction logic in the interaction binding message. In this way, a user can choose to bind or unbind the two devices according to his/her own requirements, so that it is convenient for the user to control the devices, and thus a use experience can be improved.

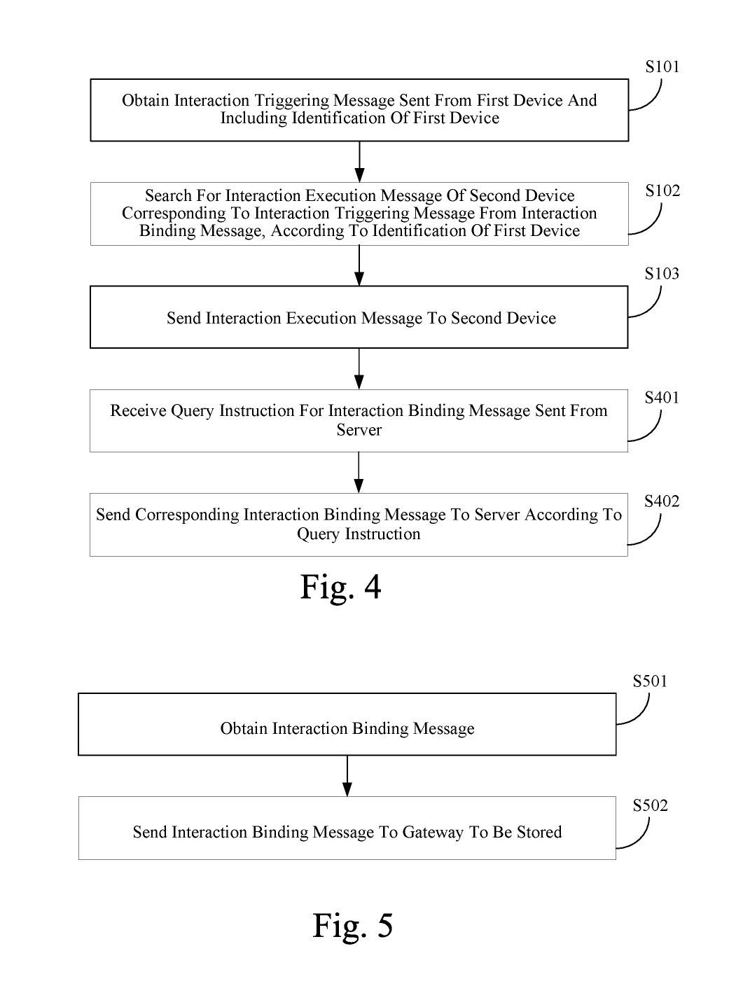

FIG. 4 is a flow chart showing a method used in a gateway for processing interactions between devices, according to another exemplary embodiment. As shown in FIG. 4, in the embodiment, the method shown in FIG. 1 further includes steps S401-S402.

In step S401, a query instruction for the interaction binding message of the gateway sent from the server is received.

In step S402, a corresponding interaction binding message is sent to the server according to the query instruction.

In this embodiment, all of interaction binding messages of the gateway or a certain interaction binding message of the gateway can be queried. For example, the user sends a query request to the server, the server sends the query instruction to the gateway according to the query request, the gateway returns a corresponding query result to the server, and the server sends the query result to the user. In this way, the user can view the interaction binding message that he/she intends to query, and thus it is convenient for the user to perform a further operation of the interaction binding message.

Server Side

FIG. 5 is a flow chart showing a method used in a server for processing interactions between devices, according to an exemplary embodiment. As shown in FIG. 5, the method for processing interactions between devices includes steps S501-S502.

In step S501, an interaction binding message is obtained. The interaction binding message includes an interaction logic between a first device and a second device, and the first device and the second device belong to a same gateway.

In an embodiment, the interaction logic is a logic of performing interaction operations between the first device and the second device. For example, the interaction binding message may include an identification of the first device, an identification of the second device, an interaction triggering message of the first device, and an interaction execution message of the second device corresponding to the interaction triggering message. Once the gateway receives the interaction triggering message sent from the first device, the second device needs to operate according to the interaction execution message. The interaction binding message may be input by operation staff of the server, and also may be sent from the first device or the second device. When the interaction binding message cannot be identified by the gateway, the serve can convert the interaction binding message into an interaction binding message in a format that can be identified by the gateway.

The interaction execution message may include operation parameters of the second device. For example, the second device may be an air conditioner, and the interaction execution message includes specific operation parameters of the air conditioner, such as an air conditioner mode, a set temperature, and so on, besides an air conditioner starting message, so as to facilitate operations of the air conditioner.

In step S502, the interaction binding message is sent to the gateway to be stored and to establish a binding relationship between the first device and the second device.

In this embodiment, the server sends the interaction binding message to the gateway, and the interaction logic between the devices is managed through the gateway, which reduces the burden of the server and improves the execution efficiency of the interaction logic between the devices. Moreover, since the interactions between the devices do not need to be performed by using the server again, the problem that the response speed is low or there is no response as a result of a communication block between the device and the server is avoided.

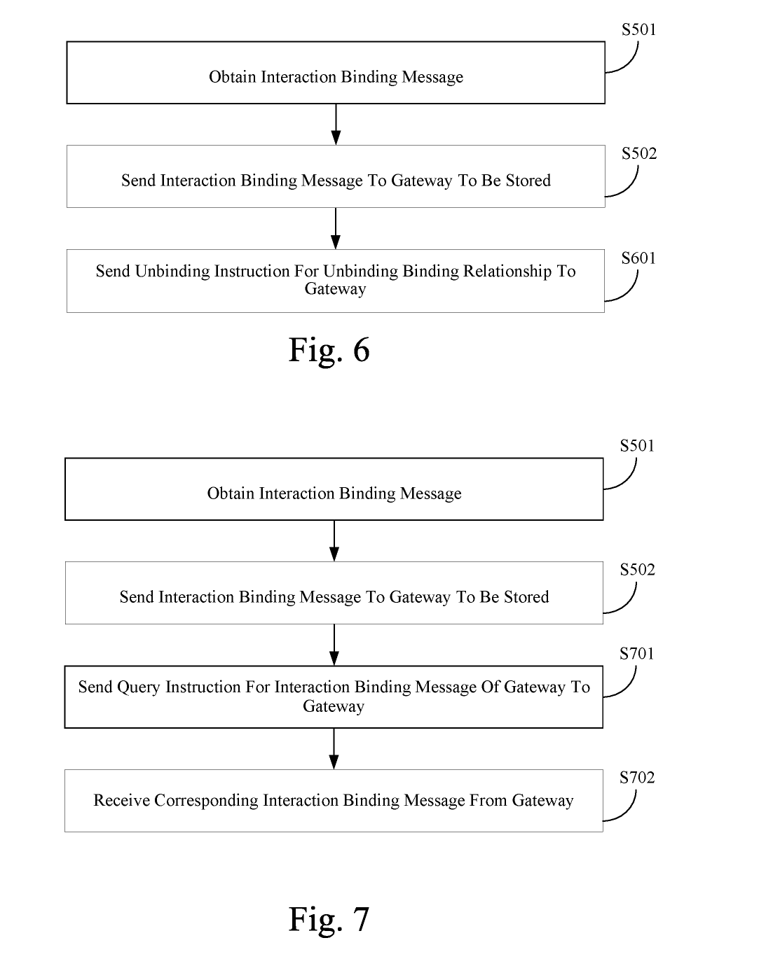

FIG. 6 is a flow chart showing a method used in a server for processing interactions between devices, according to another exemplary embodiment. As shown in FIG. 6, in the embodiment, the method shown in FIG. 5 further includes step S601.

In step S601, an unbinding instruction for unbinding the binding relationship is sent to the gateway, so that the gateway unbinds the binding relationship according to the unbinding instruction.

In this embodiment, two devices with the established binding relationship in the gateway can be unbound, and the two unbound devices will not operate according to the interaction logic in the interaction binding message. In this way, a user can choose to bind or unbind the two devices according to his/her own requirements, so that it is convenient for the user to control the devices, and thus a use experience can be improved.

FIG. 7 is a flow chart showing a method used in a server for processing interactions between devices, according to another exemplary embodiment. As shown in FIG. 7, in the embodiment, the method shown in FIG. 5 further includes steps S701-S702.

In step S701, a query instruction for the interaction binding message of the gateway is sent to the gateway.

In step S702, a corresponding interaction binding message sent from the gateway according to the query instruction is received.

In this embodiment, all of interaction binding messages of the gateway or a certain interaction binding message of the gateway can be queried. For example, the user sends a query request to the server, the server sends the query instruction to the gateway according to the query request, the gateway returns a corresponding query result to the server, and the server sends the query result to the user. In this way, the user can view the interaction binding message that he/she intends to query, and thus it is convenient for the user to perform a further operation of the interaction binding message.

In the following, the technical solution of the present disclosure will be described in details in a specific embodiment.

For example, the user hopes that when detecting that a current air quality is poor, a PM2.5 sensor using a Bluetooth protocol sends an instruction to start a smart air cleaner using the Bluetooth protocol at home, in which these two devices are both connected to a same Bluetooth gateway at the user's home. Thus, the interaction logic between the devices can be set in a terminal, and a terminal application (app) can send the setting by the user to a server. When detecting that the relevant devices set by the user are devices 1 and 2 belonging to the gateway of the user, the server sends an interaction binding message to the gateway. For example, a format of the interaction binding message is: {sid1, event1, sid2, method2, params}, in which sid1 is an identification of device 1; event1 is an interaction triggering message sent from device 1; sid2 is an identification of device 2; method2 is an interaction execution message of device 2; params are parameters of the message executed by device 2. The interaction binding message indicates the logic that the interaction triggering message event1 of device 1 is bound with the interaction execution message method2 of device 2, i.e., when device 1 generates the interaction triggering message event1, device 2 executes the interaction execution message method2 automatically, and the parameters of method2 are params. In the above example, the interaction triggering message event1 is that the PM2.5 sensor detects that particulate matter up to 2.5 micrometers in size (PM2.5) in the air exceeds a standard, and the interaction execution message method2 is starting the smart air cleaner.

Thus, after the Bluetooth PM2.5 sensor detects that PM2.5 in the air exceeds the standard, the Bluetooth PM2.5 sensor sends the interaction triggering message event1 including its own identification (sid1) to the gateway. After receiving the message, the gateway finds the interaction logic set by the user in the interaction binding message pre-stored and sends the interaction execution message method2 to the Bluetooth air cleaner (sid2), and the Bluetooth air cleaner starts to operate according to the message.

Thus, the interaction logic between the devices is managed through the gateway, which reduces the burden of the server and improves the execution efficiency of the interaction logic. Moreover, since the interactions between the devices do not need to be performed by using the server, the problem that the response speed is low or there is no response as a result of a communication block between the device and the server is avoided.

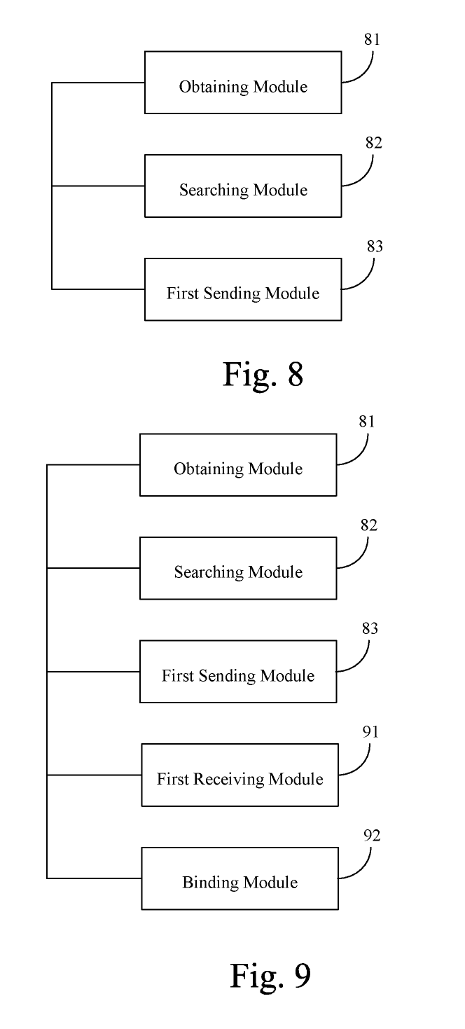

Corresponding to the above method for processing interactions between devices provided by embodiments of the present disclosure, embodiments of the present disclosure further provide an apparatus used in a gateway for processing interactions between devices. FIG. 8 is a block diagram illustrating such an apparatus used in the gateway for processing interactions between devices, according to an exemplary embodiment. As shown in FIG. 8, the apparatus includes: an obtaining module 81 configured to obtain an interaction triggering message sent from a first device belonging to the gateway and including an identification of the first device; a searching module 82 configured to search for an interaction execution message of a second device corresponding to the interaction triggering message from a pre-stored interaction binding message, according to the identification of the first device, in which the second device belongs to the gateway and the interaction binding message includes an interaction logic between the first device and the second device; and a first sending module 83 configured to send the interaction execution message to the second device, in which the second device is configured to operate according to the interaction execution message.

In an embodiment, the interaction binding message includes the identification of the first device, an identification of the second device, the interaction triggering message of the first device, and the interaction execution message of the second device corresponding to the interaction triggering message.

In an embodiment, the interaction execution message includes operation parameters of the second device.

FIG. 9 is a block diagram illustrating an apparatus for processing interactions between devices, according to another exemplary embodiment. As shown in FIG. 9, in the embodiment, the apparatus shown in FIG. 8 further includes: a first receiving module 91 configured to receive and store the interaction binding message sent from a server; and a binding module 92 configured to establish a binding relationship between the first device and the second device according to the interaction binding message.

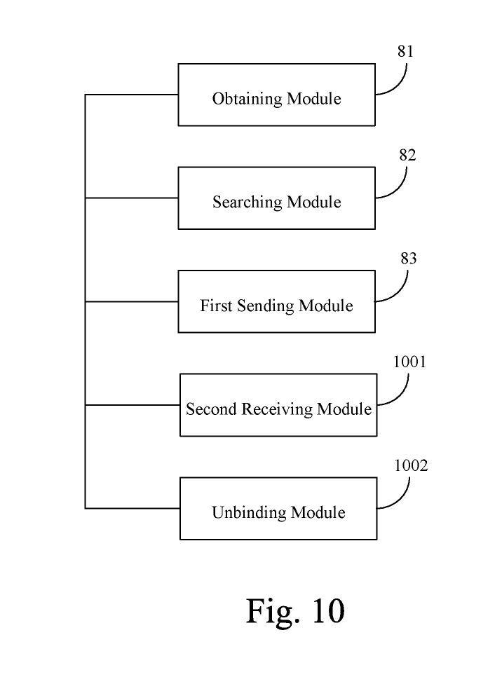

FIG. 10 is a block diagram illustrating an apparatus for processing interactions between devices, according to another exemplary embodiment. As shown in FIG. 10, in the embodiment, the apparatus shown in FIG. 8 further includes: a second receiving module 1001 configured to receive an unbinding instruction for unbinding the binding relationship sent from the server; and an unbinding module 1002 configured to unbind the binding relationship according to the unbinding instruction.

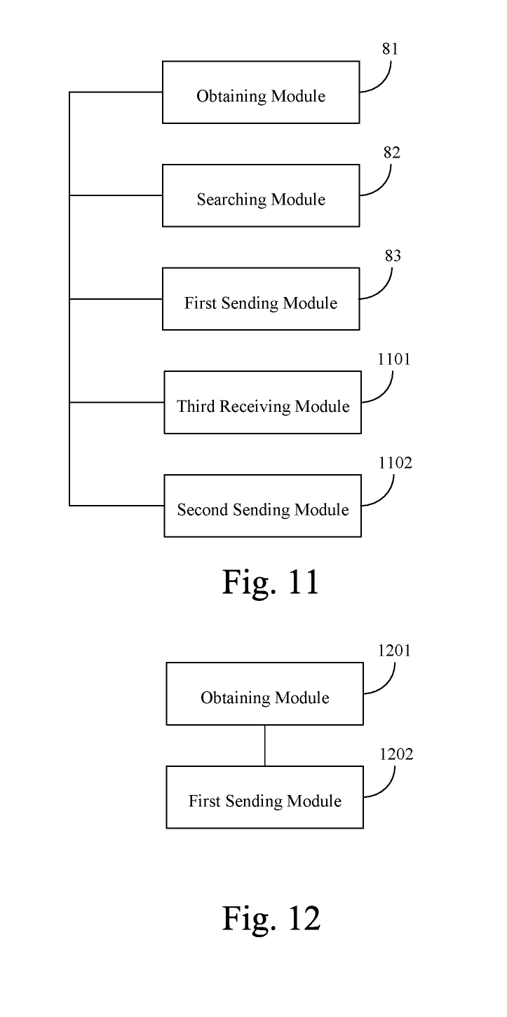

FIG. 11 is a block diagram illustrating an apparatus for processing interactions between devices, according to another exemplary embodiment. As shown in FIG. 11, in the embodiment, the apparatus shown in FIG. 8 further includes: a third receiving module 1101 configured to receive a query instruction for the interaction binding message of the gateway sent from the server; and a second sending module 1102 configured to send a corresponding interaction binding message to the server according to the query instruction.

Corresponding to the above method for processing interactions between devices provided by embodiments of the present disclosure, embodiments of the present disclosure further provide an apparatus used in a server for processing interactions between devices. FIG. 12 is a block diagram illustrating such an apparatus in the server for processing interactions between devices, according to an exemplary embodiment. As shown in FIG. 12, the apparatus includes: an obtaining module 1201 configured to obtain an interaction binding message, the interaction binding message including an interaction logic between a first device and a second device, the first device and the second device belonging to a same gateway; and a first sending module 1202 configured to send the interaction binding message to the gateway to be stored and to establish a binding relationship between the first device and the second device.

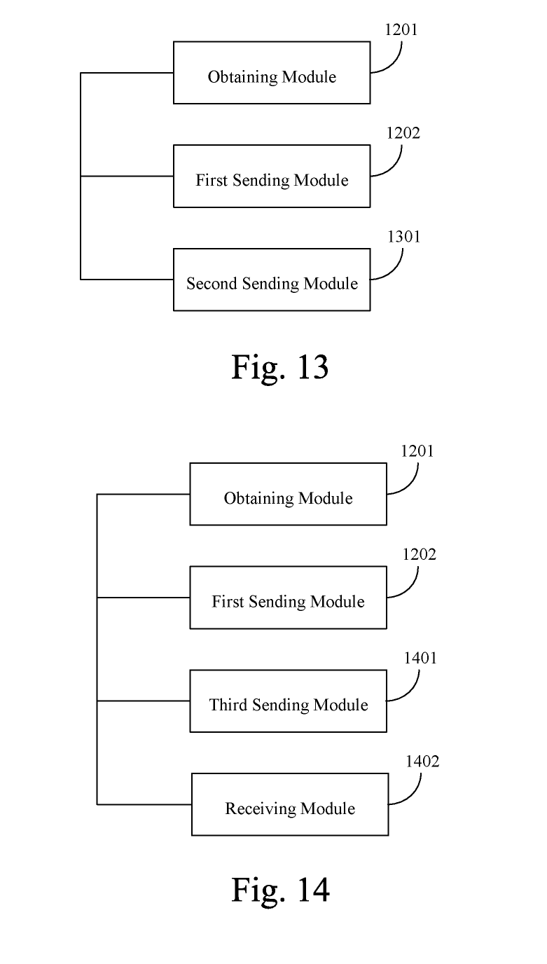

FIG. 13 is a block diagram illustrating an apparatus in a server for processing interactions between devices, according to another exemplary embodiment. As shown in FIG. 13, in the embodiment, the apparatus shown in FIG. 12 further includes a second sending module 1301 configured to send an unbinding instruction for unbinding the binding relationship to the gateway, so that the gateway unbinds the binding relationship according to the unbinding instruction.

FIG. 14 is a block diagram illustrating an apparatus in a server for processing interactions between devices, according to another exemplary embodiment. As shown in FIG. 14, in the embodiment, the apparatus shown in FIG. 12 further includes: a third sending module 1401 configured to send a query instruction for the interaction binding message of the gateway to the gateway; and a receiving module 1402 configured to receiving a corresponding interaction binding message sent from the gateway according to the query instruction.

With respect to the apparatus in the above embodiments, the specific manners for performing operations for individual modules therein have been described in detail in the embodiments regarding the methods, which will not be elaborated herein.

The present disclosure also provides an apparatus used in a gateway for processing interactions between devices, including: a processor; and a memory for storing instructions executable by the processor. The processor is configured to: obtain an interaction triggering message sent from a first device belonging to the gateway and including an identification of the first device; search for an interaction execution message of a second device corresponding to the interaction triggering message from a pre-stored interaction binding message, according to the identification of the first device, in which the second device belongs to the gateway and the interaction binding message includes an interaction logic between the first device and the second device; and send the interaction execution message to the second device, in which the second device is configured to operate according to the interaction execution message.

In exemplary embodiments, the processor is further configured to: receive and store the interaction binding message sent from a server; and establish a binding relationship between the first device and the second device according to the interaction binding message.

The interaction binding message includes the identification of the first device, an identification of the second device, the interaction triggering message of the first device, and the interaction execution message of the second device corresponding to the interaction triggering message.

In exemplary embodiments, the processor is further configured to: receive an unbinding instruction for unbinding the binding relationship sent from the server; and unbind the binding relationship according to the unbinding instruction.

The interaction execution message includes operation parameters of the second device.

In exemplary embodiments, the processor is further configured to: receive a query instruction for the interaction binding message of the gateway sent from the server; and send a corresponding interaction binding message to the server according to the query instruction.

The present disclosure also provides an apparatus used in a server for processing interactions between devices, including: a processor; and a memory for storing instructions executable by the processor. The processor is configured to: obtain an interaction binding message, the interaction binding message including an interaction logic between a first device and a second device, the first device and the second device belonging to a same gateway; and send the interaction binding message to the gateway to be stored and to establish a binding relationship between the first device and the second device.

The interaction binding message includes an identification of the first device, an identification of the second device, an interaction triggering message of the first device, and an interaction execution message of the second device corresponding to the interaction triggering message.

In exemplary embodiments, the processor is further configured to send an unbinding instruction for unbinding the binding relationship to the gateway, so that the gateway unbinds the binding relationship according to the unbinding instruction.

In exemplary embodiments, the processor is further configured to: send a query instruction for the interaction binding message of the gateway to the gateway; and receive a corresponding interaction binding message sent from the gateway according to the query instruction.

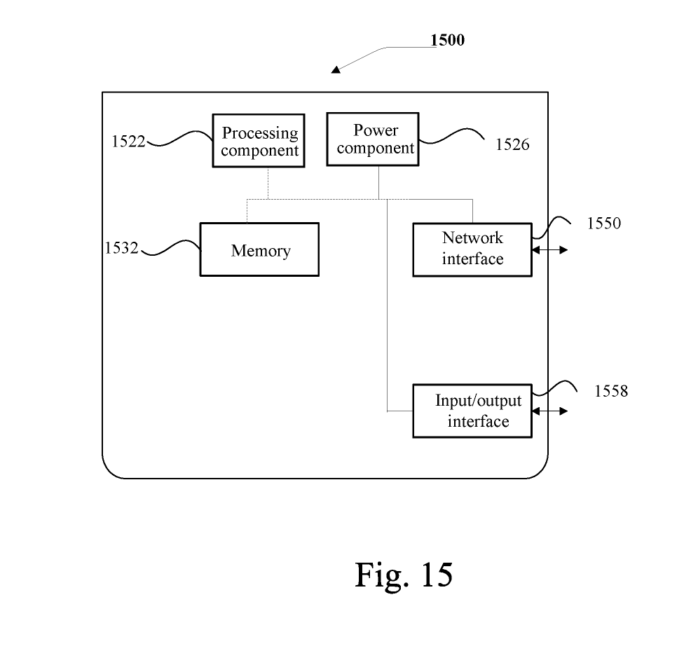

FIG. 15 is a block diagram of an apparatus 1500 for processing interactions between devices, according to an exemplary embodiment. For example, the apparatus 1500 may be provided as a gateway, a part of a gateway, a server, or a part of a server.

Referring to FIG. 15, the apparatus 1500 may include a processing component 1522 which further includes one or more processors, and memory resource represented by a memory 1532 and configured to store instructions executable by the processing component 1522, such as application programs. The application programs stored in the memory 1532 may include one or more modules, in which each module corresponds to a set of instructions. Further, the processing component 1522 may be configured to execute instructions so as to perform the above methods.

The apparatus 1500 may also include a power component 1526 configured to execute a power management of the apparatus 1500, a wired or wireless network interface 1550 configured to connect the apparatus 1500 to the Internet, and an input/output interface 1558. The apparatus 1500 may be operated based on an operating system stored in the memory 1532, such as Windows Server™, Mac OS X™, Unix™, Linux™, FreeBSD™, or the like.

Other embodiments of the present disclosure will be apparent to those skilled in the art from consideration of the specification and practice of the present disclosure disclosed here. This application is intended to cover any variations, usages, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method used in a gateway for processing interactions between devices, comprising:
obtaining an interaction triggering message sent from a first device belonging to the gateway and comprising an identification of the first device;
searching for an interaction execution message of a second device corresponding to the interaction triggering message from a pre-stored interaction binding message, according to the identification of the first device, wherein the second device belongs to the gateway and the interaction binding message comprises an interaction logic between the first device and the second device; and
sending the interaction execution message to the second device, wherein the second device is configured to operate according to the interaction execution message.

2. The method of claim 1, further comprising:
receiving and storing the interaction binding message sent from a server; and
establishing a binding relationship between the first device and the second device according to the interaction binding message.

3. The method of claim 1, wherein the interaction binding message comprises the identification of the first device, an identification of the second device, the interaction triggering message of the first device, and the interaction execution message of the second device corresponding to the interaction triggering message.

4. The method of claim 2, further comprising:
receiving an unbinding instruction for unbinding the binding relationship sent from the server; and
unbinding the binding relationship according to the unbinding instruction.

5. The method of claim 1, wherein the interaction execution message comprises operation parameters of the second device.

6. The method of claim 1, further comprising:
receiving a query instruction for the interaction binding message of the gateway sent from the server; and
sending a corresponding interaction binding message to the server according to the query instruction.

7. An apparatus used in a gateway for processing interactions between devices, comprising:
a processor;
a memory for storing instructions executable by the processor;
wherein the processor is configured to:
obtain an interaction triggering message sent from a first device belonging to the gateway and comprising an identification of the first device;
search for an interaction execution message of a second device corresponding to the interaction triggering message from a pre-stored interaction binding message, according to the identification of the first device, wherein the second device belongs to the gateway and the interaction binding message comprises an interaction logic between the first device and the second device; and
send the interaction execution message to the second device, wherein the second device is configured to operate according to the interaction execution message.

8. The apparatus of claim 7, wherein the processor is further configured to:
receive and store the interaction binding message sent from a server; and
establish a binding relationship between the first device and the second device according to the interaction binding message.

9. The apparatus of claim 7, wherein the interaction binding message comprises the identification of the first device, an identification of the second device, the interaction triggering message of the first device, and the interaction execution message of the second device corresponding to the interaction triggering message.

10. The apparatus of claim 8, wherein the processor is further configured to:
receive an unbinding instruction for unbinding the binding relationship sent from the server; and
unbind the binding relationship according to the unbinding instruction.

11. The apparatus of claim 7, wherein the interaction execution message comprises operation parameters of the second device.

12. The apparatus of claim 7, wherein the processor is further configured to:
receive a query instruction for the interaction binding message of the gateway sent from the server; and
send a corresponding interaction binding message to the server according to the query instruction.

13. A non-transitory computer-readable storage medium having stored therein instructions that, when executed by a processor of a gateway, cause the gateway to perform a method for processing interactions between devices, the method comprising:
obtaining an interaction triggering message sent from a first device belonging to the gateway and comprising an identification of the first device;
searching for an interaction execution message of a second device corresponding to the interaction triggering message from a pre-stored interaction binding message, according to the identification of the first device, wherein the second device belongs to the gateway and the interaction binding message comprises an interaction logic between the first device and the second device; and
sending the interaction execution message to the second device, wherein the second device is configured to operate according to the interaction execution message.

14. The non-transitory computer-readable storage medium of claim 13, wherein the method further comprises:
receiving and storing the interaction binding message sent from a server; and
establishing a binding relationship between the first device and the second device according to the interaction binding message.

15. The non-transitory computer-readable storage medium of claim 13, wherein the interaction binding message comprises the identification of the first device, an identification of the second device, the interaction triggering message of the first device, and the interaction execution message of the second device corresponding to the interaction triggering message.

16. The non-transitory computer-readable storage medium of claim 14, wherein the method further comprises:
receiving an unbinding instruction for unbinding the binding relationship sent from the server; and
unbinding the binding relationship according to the unbinding instruction.

17. The non-transitory computer-readable storage medium of claim 13, wherein the interaction execution message comprises operation parameters of the second device.

18. The non-transitory computer-readable storage medium of claim 13, wherein the method further comprises:
receiving a query instruction for the interaction binding message of the gateway sent from the server; and
sending a corresponding interaction binding message to the server according to the query instruction.
